(19) United States
(12) Patent Application Publication
(10) Pub. No.: US 2025/0131545 A1
(43) Pub. Date: Apr. 24, 2025

(54) COUPLED INVERSE TONE MAPPING AND TONE MAPPING

(71) Applicant: InterDigital CE Patent Holdings, SAS, Cesson Sevigne (FR)

(72) Inventors: David Touze, Rennes (FR); Laurent Cauvin, Chevaigne (FR); Patrick Lopez, Livre sur Changeon (FR); Robin Le Naour, Cesson-Sevigne (FR); Jean-Luc Jumpertz, Rennes (FR)

(21) Appl. No.: 18/704,836

(22) PCT Filed: Oct. 11, 2022
(86) PCT No.: PCT/EP2022/078245

§ 371 Date: Apr. 25, 2024

(30) Foreign Application Priority Data
Oct. 27, 2021 (EP) 21306502.2

(51) Int. Cl. G06T 5/92; G06T 11/00

(52) U.S. Cl. CPC G06T 5/92; G06T 11/001; G06T 2207/10016; G06T 2207/20008; G06T 2207/20208

(57) ABSTRACT

A method comprising: obtaining standard dynamic range data; obtaining (601) information representative of an inverse tone mapping process adapted to generate high dynamic range data from the standard dynamic range data and inserting the information in metadata; providing video data representative of the standard dynamic range data (600) along with the metadata (602).

### 1. TECHNICAL FIELD

At least one of the present embodiments generally relates to the field of production of High Dynamic Range (HDR) video and more particularly to a method, a device and an equipment to regenerate SDR data, after inverse tone mapping and tone mapping, that are as close as possible to original SDR data.

### 2. BACKGROUND

Recent advancements in display technologies are beginning to allow for an extended dynamic range of color, luminance and contrast in images to be displayed. The term image refers here to an image content that can be for example a video or a still picture or image.

High-dynamic-range video (HDR video) describes video having a dynamic range greater than that of standard-dynamic-range video (SDR video). HDR video involves capture, production, content/encoding, and display. HDR capture and display devices are capable of brighter whites and deeper blacks. To accommodate this, HDR encoding standards allow for a higher maximum luminance and use at least a 10-bit dynamic range (compared to 8-bit for non-professional and 10-bit for professional SDR video) in order to maintain precision across this extended range.

HDR production is a new domain and there will be a transition phase during which both HDR contents and SDR contents will coexist. During this coexistence phase, a same live content will be produced simultaneously in a HDR and a SDR version. A user can then display the HDR or the SDR version of the content depending on his preferences or capabilities.

The current trend of the content production industry is:
first, to produce HDR contents and then to derive automatically SDR contents from the HDR contents using automatic tools; and,
second, to apply a controlled and safe approach for the HDR production to avoid delivering bad HDR contents to users, that could be counterproductive for the HDR technology.

In that respect, some recommendations have been introduced by the ITU-R document “Report ITU-R BT.2408-3, Guidance for operational practices in HDR television production, July 2019”, just called BT.2408-3 report in the following. One important recommendation introduced in the BT.2408-3 report is a constraint of HDR Diffuse White set to a fixed value equal to “203” nits. This constraint allows using fixed 3D-LUTs (Look-Up Tables) to implement SDR to HDR conversions (i.e. Inverse Tone Mapping (ITM)) and HDR to SDR conversions (Tone Mapping (TM)).

Live HDR contents are generally a mixture of a main HDR video content with other types of contents, such as adverts or graphics for logos and scores. These added contents can be SDR and need therefore to be converted in HDR before being mixed with the main HDR video content. Since the resulting mixed HDR content is likely to be converted in SDR, a new constraint appears: the SDR content resulting from the so-called SDR-HDR-SDR round trip conversion (i.e. ITM conversion followed by a TM conversion (for SDR delivery)) of these added contents must be identical to the original SDR content. The same SDR-HDR-SDR round trip constraint exist when a content producer generates a HDR content from an original SDR content but wishes that a SDR content generated, for any reason, from this HDR content to be identical to the original SDR content.

The recommendations of the BT.2408-3 report offer a solution to respect the SDR-HDR-SDR round trip constraint. However, the constraints applied to the HDR contents render these HDR contents dull and not appealing. In addition, with these constraints, HDR cameras are not exploited to their maximum capabilities and HDR cameramen/director of photography are very restricted in their choices/artistic intent.

It is desirable to overcome the above drawbacks.

It is particularly desirable to propose a system that allows more flexibility, more artistic freedom in the HDR creation and therefore allows obtaining more appealing HDR content,

### 3. BRIEF SUMMARY

In a first aspect, one or more of the present embodiments provide a method comprising: obtaining standard dynamic range data; obtaining information representative of an inverse tone mapping process adapted to generate high dynamic range data from the standard dynamic range data and inserting the information in metadata; providing video data representative of the standard dynamic range data along with the metadata.

In an embodiment, the video data representative of the standard dynamic range data comprises the standard dynamic range data or high dynamic range data obtained from the standard dynamic range data by applying the inverse tone mapping process.

In an embodiment, the information is representative of an inverse tone mapping curve or of a tone mapping curve.

In an embodiment, when the information is representative of a tone mapping curve, computing an inverse of an inverse tone mapping curve used to define the inverse tone mapping process.

In an embodiment, the method comprises computing a first look-up table and a second look-up table from the inverse of the inverse tone mapping curve, the first look-up table being adapted for tone mapping a luminance component of high dynamic range data and the second look-up table being adapted for correcting color components of the high dynamic range data and estimating first variables representative of a tone mapping function and second variables representative of a color correction function from the first and second look-up tables, the first and the second variables being the information representative of the inverse tone mapping process inserted in the metadata.

In a second aspect, one or more of the present embodiments provide a method comprising: obtaining a video data representative of standard dynamic range data; determining if metadata comprising first information representative of an inverse tone mapping process adapted to generate high dynamic range data from the standard dynamic range data were obtained along with the video data; and, applying a first tone mapping process to high dynamic range data obtained from the video data based on the first information responsive to obtaining the metadata; otherwise, computing second information representative of a second tone mapping process from the video data representative of the standard dynamic range data and applying the second tone mapping process to high dynamic range data obtained from the video data based on the information.

In an embodiment, the video data comprises the standard dynamic range data or high dynamic range data obtained from the standard dynamic range data by applying the inverse tone mapping process.

In an embodiment, the information is representative of an inverse tone mapping curve or of a tone mapping curve.

In an embodiment, the method comprises, when the information is representative of an inverse tone mapping curve, inverting the inverse tone mapping curve.

In a third aspect, one or more of the present embodiments provide a device comprising electronic circuitry configured for: obtaining standard dynamic range data; obtaining information representative of an inverse tone mapping process adapted to generate high dynamic range data from the standard dynamic range data and inserting the information in metadata; providing video data representative of the standard dynamic range data along with the metadata.

In an embodiment, the video data representative of the standard dynamic range data comprises the standard dynamic range data or high dynamic range data obtained from the standard dynamic range data by applying the inverse tone mapping process.

In an embodiment, the information is representative of an inverse tone mapping curve or of a tone mapping curve.

In an embodiment, when the information is representative of a tone mapping curve, the electronic circuitry is further configured for computing an inverse of an inverse tone mapping curve used to define the inverse tone mapping process.

In an embodiment, the electronic circuitry is further configured for computing (6012) a first look-up table and a second look-up table from the inverse of the inverse tone mapping curve, the first look-up table being adapted for tone mapping a luminance component of high dynamic range data and the second look-up table being adapted for correcting color components of the high dynamic range data and for estimating (6013) first variables representative of a tone mapping function and second variables representative of a color correction function from the first and second look-up tables, the first and the second variables being the information representative of the inverse tone mapping process inserted in the metadata.

In a fourth aspect, one or more of the present embodiments provide a device comprising electronic circuitry configured for: obtaining video data representative of the standard dynamic range data; determining if metadata comprising first information representative of an inverse tone mapping process adapted to generate high dynamic range data from the standard dynamic range data were obtained along with the video data; and, applying a first tone mapping process to high dynamic range data obtained from the video data based on the first information responsive to a reception of the metadata; otherwise, computing second information representative of a second tone mapping process from the video data representative of the standard dynamic range data and applying the second tone mapping process to high dynamic range data obtained from the video data based on the information.

In an embodiment, the video data comprises the standard dynamic range data or high dynamic range data obtained from the standard dynamic range data by applying the inverse tone mapping process.

In an embodiment, the information is representative of an inverse tone mapping curve or of a tone mapping curve.

In an embodiment, when the information is representative of an inverse tone mapping curve, the electronic circuitry is further configured for inverting the inverse tone mapping curve.

In a fifth aspect, one or more of the present embodiments provide a signal generated using the method of the first aspect or by using the device of the third aspect.

In a sixth aspect, one or more of the present embodiments provide a computer program comprising program code instructions for implementing the method according to the first or the second aspect.

In a seventh aspect, one or more of the present embodiments provide a non-transitory information storage medium storing program code instructions for implementing the method according to the first or the second aspect.

### 4. BRIEF SUMMARY OF THE DRAWINGS

FIG. 1A illustrates a scale of luminance values in which appears the diffuse white;

FIG. 1B illustrates the separation of a scale of luminance values when the diffuse white is fixed to “203” nits;

FIG. 1C illustrates schematically a context of various embodiments;

FIG. 2 illustrates a current Single-stream HDR/SDR workflow;

FIG. 3 illustrates a Single-stream HDR/SDR workflow according to an embodiment;

FIG. 4 illustrates a known SL-HDR preprocessor;

FIG. 5 illustrates a known inverse tone mapping process;

FIG. 6A illustrates schematically an example of ITM process according to an embodiment;

FIG. 6B illustrates schematically an example of TM process according to an embodiment;

FIG. 6C details a step of the example of TM process according to an embodiment in the context of SL-HDR1;

FIG. 7A illustrates a first example of ITM curve;

FIG. 7B illustrates a second example of ITM curve;

FIG. 8 illustrates an example of process for determining the luminance mapping variables;

FIG. 9 illustrates an example of process for determining the color correction adjustment variables;

FIG. 10A illustrates schematically an example of process according to a variant embodiment;

FIG. 10B illustrates a detail of a step of the example of process according to a variant embodiment in the context of SL-HDR1;

FIG. 11A illustrates schematically an example of hardware architecture of a processing module able to implement various aspects and embodiments;

FIG. 11B illustrates a block diagram of an example of a first system in which various aspects and embodiments are implemented;

FIG. 11C illustrates a block diagram of an example of a second system in which various aspects and embodiments are implemented;

### 5. DETAILED DESCRIPTION

As mentioned earlier, the BT.2408-3 report proposed some recommendations and in particular a constraint of diffuse white. The diffuse white is defined in BT.2408-3 report as “the white provided by a card that approximates to a perfect reflecting diffuser by being spectrally grey, not just calorimetrically grey, by minimizing specular highlights and minimizing spectral power absorptance”. A “perfect reflecting diffuser” is defined as an “ideal isotropic, nonfluorescent diffuser with a spectral radiance factor equal to unity at each wavelength of interest”.

In other words, the diffuse white is a luminance level of a video signal that separates:
the scene with all the details, corresponding to the luminance levels that are below the diffuse white;
the speculars: very bright pixels, generally close to white and with very few details, corresponding to the luminance levels that are above the diffuse white level.

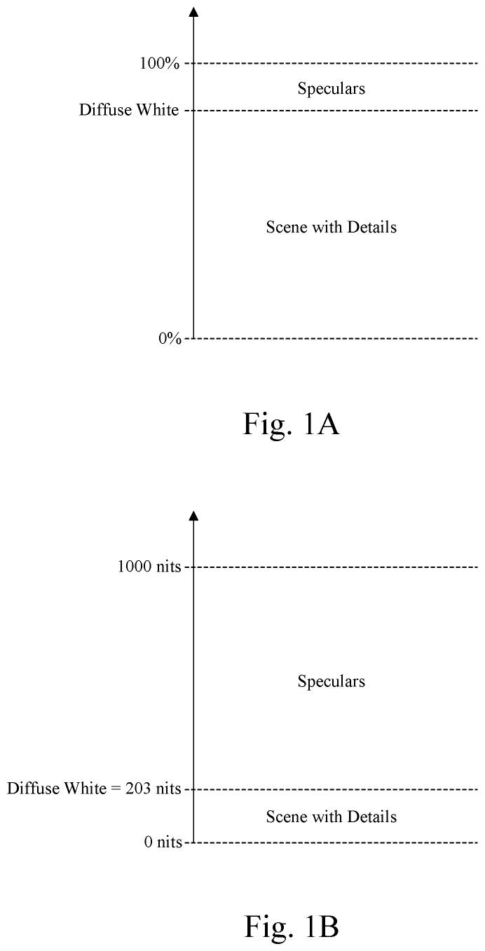

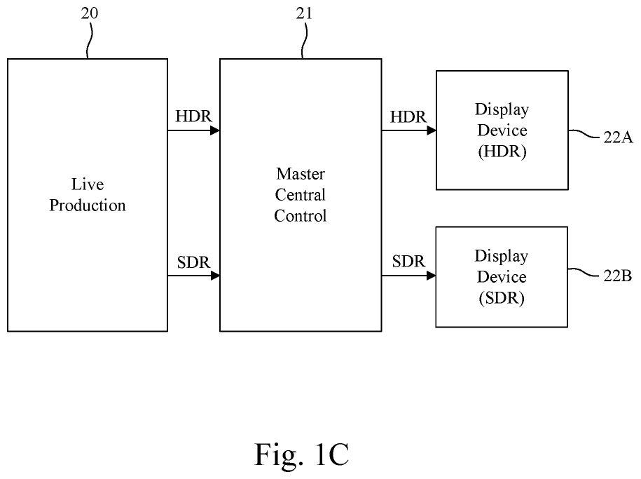

FIG. 1A illustrates a scale of luminance values in which appears the diffuse white. As can be seen, the diffuse white separates the sets of all possible luminance values in two parts.

The diffuse white notion is valid for HDR signals and for SDR signals.

The BT.2408-3 report specifies that HDR Diffuse White is equal to 203 nits.

However, the “203” nits constraint is only a recommendation and many content producers disagree with that recommendation.

Indeed, this specification brings a major disadvantage: the HDR content is constrained, i.e. for a typical 1000 nits HDR content, only a small amount of the HDR luminance range [0-203 nits] is dedicated to the details of a scene, while the largest part of the HDR luminance range [203-1000 nits] is reserved for speculars that bring no detail.

FIG. 1B illustrates the separation of a scale of luminance values when the diffuse white is fixed to “203” nits.

One of the reasons for this restriction is a need for controlled and “very safe” live HDR content production. In addition, this restriction has the following advantages:
the implementation of the conversion from HDR to SDR (i.e. the tone mapping (TM)) is simpler as the HDR diffuse white defined at “203” nits needs to be mapped to SDR diffuse white that is generally defined between 90% and 100% SDR (i.e. between 90 nits and 100 nits). The tone mapping can be therefore implemented using a very basic static 3D-LUTs.
the implementation of the conversion from SDR to HDR, (i.e. the inverse tone mapping (ITM)) is also simpler for the same reason and the inverse tone mapping can also be implemented with very basic static 3D-LUTs.

However, such ratio between the luminance values allocated to the details of the scene and the luminance values allocated to the speculars induced by the diffuse white at “203” nits render the resulting HDR images very dull and not appealing.

The following embodiments allow to get rid of these drawbacks by proposing a system that:
allows more flexibility and more artistic freedom in the HDR creation and therefore allows obtaining more appealing HDR contents by using dynamic conversions for both HDR to SDR (Tone Mapping) and SDR to HDR (Inverse Tone Mapping)
allows coupling ITM and TM processing (the TM processing applies the inverse of the ITM processing) for perfect SDR-HDR-SDR round-trip.

Indeed, one characteristic of the current HDR production environments is that ITM tools and TM tools are working independently. Consequently, there is no correlation between algorithms applied in the ITM tools and algorithms applied in the TM tools and no communication between these tools that specifies characteristics of a ITM (respectively a TM) conversion applied before a TM (respectively a ITM) conversion.

FIG. 1C illustrates an example context in which various embodiments are implemented.

In FIG. 1C, a live production system 20 is communicating with a master central control system 21. The live production system 20 provides simultaneously a HDR version and a SDR version of a same live content. The master central control system 21 then encodes the same or an enriched version of these SDR and HDR versions and provides these encoded versions to devices 22A and 22B. In an embodiment, the master control system 21 encodes the HDR and SDR versions using an AVC ((ISO/CEI 14496-10/ITU-T H.264) encoder, an HEVC (ISO/IEC 23008-2—MPEG-H Part 2, High Efficiency Video Coding/ITU-T H.265)) encoder, a VVC (ISO/IEC 23090-3—MPEG-I, Versatile Video Coding/ITU-T H.266) encoder or any other encoder.

Devices 22A and 22B are display devices such as a PC, a TV, a smartphone, a tablet or a head mounted display are a device connected to a display device such as a set top box. The device 22A that have HDR capabilities receives an encoded HDR version. The device 22B that have only SDR capabilities receives an encoded SDR version.

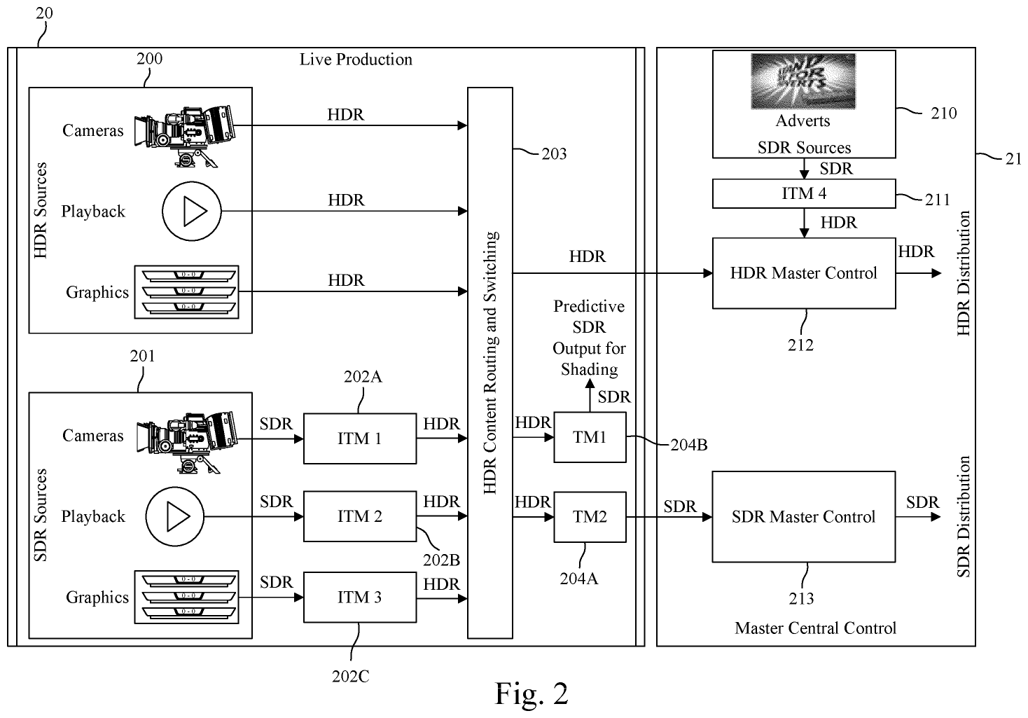

FIG. 2 illustrates a current Single-stream HDR/SDR workflow. FIG. 2 provides details on the live production system 20 and the master central control system 21.

The live production system 20 comprises two sources: a HDR source 200 and a SDR source 201. Each source comprises at least one of a camera, a playback system or a system that generates graphics. The SDR source 201 is connected to a plurality of ITM tools:
one ITM tool 202A (ITM1) for SDR camera output up-conversion to HDR;
one ITM tool 202B (ITM2) for SDR playback content up-conversion to HDR; and,
one ITM tool 202C (ITM3) for SDR graphics (score insertion for instance) content up-conversion to HDR.

A HDR content routing and switching system ingests the multiple HDR inputs that come either from the HDR source 200 or from the SDR source 201 and then generates multiple HDR outputs.

From these HDR outputs, multiple TM tools are used:
A TM tool 204B (TM1) for generating a predictive SDR output that is used by shaders operators that assess a quality of the generated SDR contents that are sent to the master central control system 21.
A TM tool 204A (TM2) for generating a SDR provided to the master central control system 21.

The master control system 21 comprises a HDR master control system 212 and a SDR master control system 213. The HDR and SDR master control systems are in charge of distributing SDR/HDR contents. In the example of FIG. 2, the master control system 21 comprises a source 210 generating adverts in SDR and an ITM tool that convert the adverts from SDR to HDR. The HDR master control system 212 receives these adverts converted in HDR and mixes these adverts with the HDR content it receives. The HDR (respectively the SDR) master control system 212 (respectively 213) encode the HDR (respectively the SDR data) it receives or resulting from a mixture of the HDR (respectively SDR) data it receives with other data. For example, the SDR and HDR data are encoded by an AVC ((ISO/CEI 14496-10/ITU-T H.264) encoder, an HEVC (ISO/IEC 23008-2—MPEG-H Part 2, High Efficiency Video Coding/ITU-T H.265)) encoder, a VVC (ISO/IEC 23090-3—MPEG-I, Versatile Video Coding/ITU-T H.266) encoder or any other encoder.

As can be seen, in the HDR production environment of FIG. 2, ITM and TM tools are running independently without any communication between these tools.

In a known implementation, each TM tool (for example the TM tool 204A (TM2) and the TM tool 204B (TM1)) of the HDR production environment of FIG. 2 is implemented in a preprocessor for instance compliant with the standards SL-HDR1 (ETSI TS 103 433 v1.4.1), called SL-HDR preprocessor in the following.

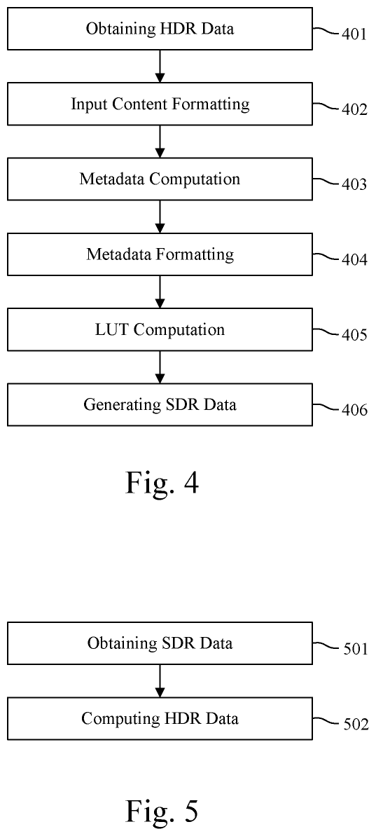

FIG. 4 illustrates a process applied by a known SL-HDR preprocessor.

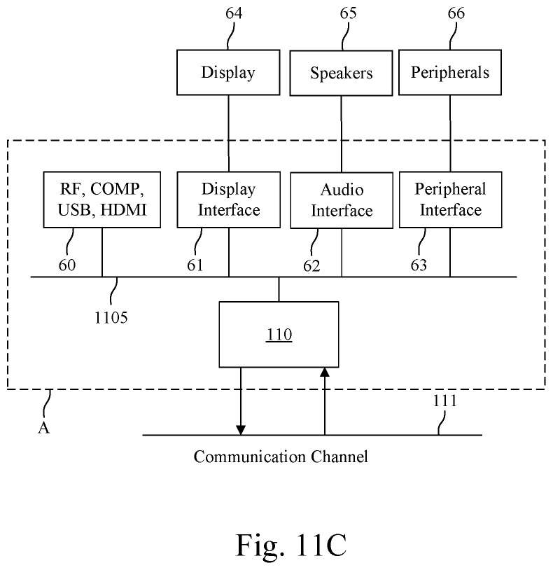

The process of FIG. 4 is for instance implemented by a processing module that is further detailed later in relation to FIG. 11A.

In a step 401, the processing module obtains HDR input data. In general, the HDR input data are in YUV format.

In a step 402, the processing module implements an input content formatting process. The input content formatting process consists in formatting the HDR input data into an internal representation.

In a step 403, the processing module analyze the formatted HDR input data to compute SL-HDR metadata. The analysis comprises in general a computation of an histogram of the formatted HDR input data. The SL-HDR metadata comprise (or are representative of):
luminance mapping variables defined in section 6.2.5 of the SL-HDR1 specification (ETSI TS 103 433 v1.4.1)
color correction adjustment variables defined in section 6.2.6 of the SL-HDR1 specification (ETSI TS 103 433 v1.4.1).

In a step 404, the processing module inserts the SL-HDR metadata in a vertical ancillary channel of a SDI (Serial Digital Interface) interface, following the standard SMPTE ST 2108-1, the SL-HDR metadata being the Dynamic Metadata Type 5 defined in section 5.3.5 of that document. This is typically a usual way to carry SL-HDR metadata between an equipment that integrates a SL-HDR preprocessor and a video encoder, such as an AVC ((ISO/CEI 14496-10/ITU-T H.264) encoder, an HEVC (ISO/IEC 23008-2—MPEG-H Part 2, High Efficiency Video Coding/ITU-T H.265)) encoder, a VVC (ISO/IEC 23090-3—MPEG-I, Versatile Video Coding/ITU-T H.266) encoder or any other encoder.

In a step 405, the processing module computes a Look-Up Table (LUT), called L-LUT, that is representative of a Tone Mapping (TM) function described by the luminance mapping variables computed in step 403 and a LUT called B-LUT that is representative of a color correction function described by the color correction adjustment variables computed in step 403. The L-LUT is a first look-up table adapted for tone mapping a luminance component of the high dynamic range data and the B-LUT being a second look-up table adapted for correcting color components of the high dynamic range data.

In a step 406, the processing module generates SDR output data from the formatted HDR input data by applying an TM process based on the L-LUT and the B-LUT.

FIG. 5 illustrates a known inverse tone mapping (ITM) process. The ITM process of FIG. 5 is typically applied by each ITM tool (ITM1 202A, ITM2 202B and ITM3 202C) of the HDR production environment of FIG. 2. The process of FIG. 5 is for instance implemented by the processing module detailed later in relation to FIG. 11A.

In a step 501, the processing module obtains SDR input data. In general, the SDR input data are in YUV format.

In a step 502, the processing module analyzes the SDR input data, computes the most appropriate Inverse Tone Mapping (ITM) curve using the result of the analysis and outputs HDR data using this ITM curve. The ITM curve is used to define the ITM process applied to the SDR data to obtain the outputted HDR data.

As can be seen, there is no link between the ITM process applied in step 502 and the TM process applied in step 406. Nothing ensures that the SDR-HDR-SDR round-trip constraint is respected by the process of FIGS. 4 and 5.

In an embodiment, it is proposed to couple the ITM and the TM tools in a HDR production system by:
creating a communication channel between the ITM and the TM tools allowing the ITM tool and the TM tools to communicate:
   either to define a HDR to SDR conversion that allows the TM tool to generate a SDR output that match the SDR input of the ITM tool, to obtain a perfect SDR-HDR-SDR round-trip;
   or to define a SDR to HDR conversion applied by the ITM tool such that the TM tool can compute an inverse HDR to SDR conversion allowing obtaining again a perfect SDR-HDR-SDR round-trip.

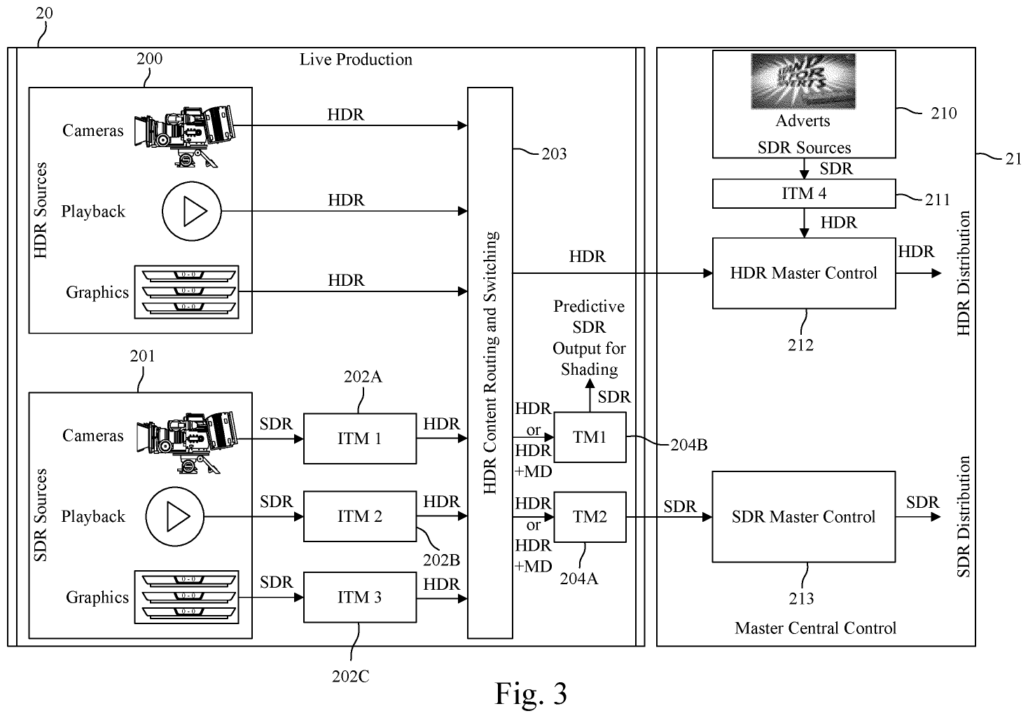

FIG. 3 illustrates a single-stream HDR/SDR workflow compliant with this embodiment.

Systems, devices and modules of FIGS. 1C and 2 appear identically in FIG. 3. In the HDR production environment of FIG. 3, ITM tools ITM1 202A, ITM2 202B and ITM3 202C now generate HDR contents along with metadata that describe either:
the HDR to SDR conversion that allow the TM tool (that understand these metadata) to generate a SDR output that match the SDR input of the ITM tool;
the SDR to HDR conversion that is applied by the ITM tool, so that the TM tool (that understand these metadata) can compute the inverse conversion.

In addition, the two TM tool (TM1 204B and TM2 204A) receives either:
the HDR content with metadata when the routing and switching tool 203 outputs contents from one of the SDR source 201. In that case, the TM tool interprets the metadata and, either, apply directly the HDR to SDR conversion described in the metadata or, use the metadata that describe the SDR to HDR conversion applied by the ITM tool to compute a TM that corresponds to the inverse of the ITM. In both cases a perfect SDR-HDR-SDR round trip is obtained;
the HDR content without metadata when the routing and switching tool 203 outputs contents from one of the HDR source 200.

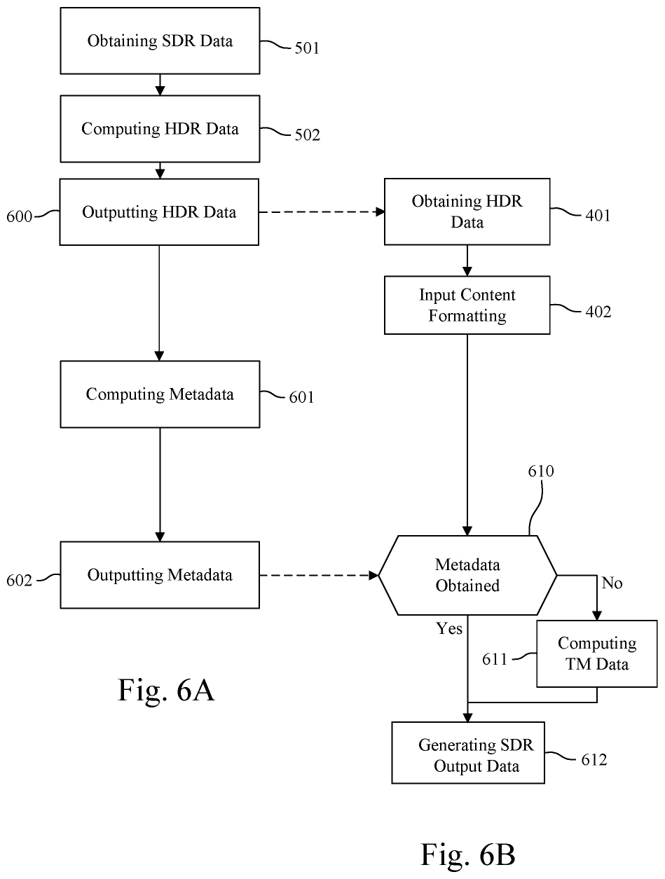

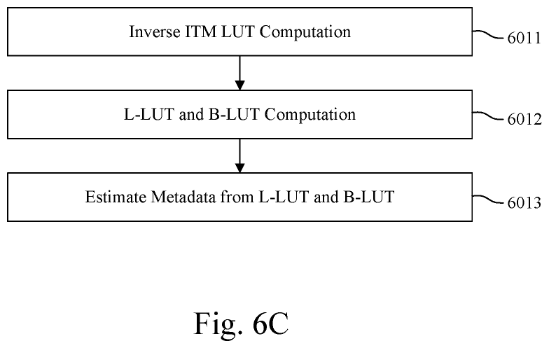

The embodiment of FIG. 3 is further detailed in the following. In particular, an example of coupling of the ITM and TM processes is detailed in relation to FIGS. 6A, 6B and 6C.

FIG. 6A illustrates schematically an example of ITM process according to an embodiment. The ITM process of FIG. 6A is typically implemented by a module in charge of generating HDR data from SDR data. The ITM process of FIG. 6A is for instance implemented by the processing module detailed later in relation to FIG. 11A.

The ITM process of FIG. 6A starts by steps 501 and 502 already explained in relation to FIG. 5.

In a step 600, the processing module provides (i.e. outputs or transmits) the computed HDR data to a module in charge of generating SDR data from the HDR data by respecting the SDR-HDR-SDR round trip constraint.

In a step 601, the processing module computes information representative of the ITM process adapted to generate the HDR data from the SDR data applied in step 502. In an embodiment of step 601, the information representative of the ITM process comprises information representative of the ITM curve computed in step 502. In a variant of step 601, the information representative of the ITM process comprises information representative of a TM curve deduced from the ITM curve computed in step 502. In step 601, the processing module inserts the information in metadata.

In a step 602, the processing module provides (i.e. outputs or transmits) the metadata to the module in charge of generating SDR data from the HDR data.

FIG. 6B illustrates schematically an example of TM process according to an embodiment. The TM process of FIG. 6B is typically applied by the module in charge of generating SDR data from the HDR data by respecting the SDR-HDR-SDR round trip constraint. The process of FIG. 6B is for instance implemented by the processing module detailed later in relation to FIG. 11A.

Steps of 401 and 402 of FIG. 4 are kept in the process of FIG. 6B. Step 403 and 404 are removed. Step 405 is replaced by a step 610. Step 406 is replaced by steps 611 and 612. One can note that in step 401, the processing module receives the HDR data generated in step 502.

In step 610, the processing module determines if it has received metadata along with the HDR data.

In no metadata were received along with the HDR data, the processing module applies a step 611. In steps 611, the processing module analyzes the formatted HDR data, and computes the most appropriate Tone Mapping (TM) curve using the result of the analysis. Step 611 is followed by step 612.

When metadata were received along with the HDR data, step 610 is followed directly by step 612.

In step 612, the processing module generates SDR output data from the formatted HDR input data by applying a TM process based either on the metadata representing the information representative of the ITM process applied in step 502 or a TM process defined by the TM curve computed in step 611. When the information representative of the ITM process represent an ITM curve, the processing module computes a TM curve from the ITM curve by inverting the ITM curve and applies a tone mapping to the HDR data using the computed TM curve. Indeed, the information representative of the ITM curve are also representative of a TM curve that can be deduced from the ITM curve. When the information representative of the ITM process represent a TM curve, the processing module use directly the TM curve to compute the SDR data.

In the following, the process of FIGS. 6A and 6B are detailed in the context of SL-HDR1 in relation to FIG. 6C. In this context, the ITM process of FIG. 6A is typically executed by a processing module of each ITM tool (ITM1 202A, ITM2 202B and ITM3 202C) of the HDR production environment of FIG. 3. The TM process of FIG. 6B is typically executed by a processing module of each TM tool (TM1 204B and TM2 204A) of the HDR production environment of FIG. 3 or by a processing module of a SL-HDR preprocessor as in FIG. 4.

FIG. 6C details step 601. Step 601 is divided in 3 steps 6011, 6012 and 6013.

In a step 6011, the processing module computes an inverse of the Inverse Tone Mapping curve computed in step 502. An example of process for computing an inverse of the Inverse Tone Mapping curve is explained in the following.

In a step 6012, the processing module computes a L-LUT and a B-LUT from the inverted Inverse Tone Mapping curve. The L-LUT and B-LUT are computed in a format adapted to the one used by a SL-HDR preprocessor.

In a step 6013, the processing module estimates the luminance mapping variables defined in section 6.2.5 of the SL-HDR1 specification from the L-LUT and the color correction adjustment variables defined in section 6.2.6 of the SL-HDR1 specification from the B-LUT.

In a step 602, when applied in the context of SL-HDR1, the processing module inserts SL-HDR metadata comprising or representative of the luminance mapping variables and the color correction adjustment variables in a vertical ancillary channel of a SDI interface, as in step 404 and provides these metadata to the module in charge of generating SDR data from the HDR data by respecting the SDR-HDR-SDR round trip constraint. In an embodiment, the SL-HDR metadata are provided in an ST2108 container.

As can be seen, in steps 600 and 602, the processing module provides a stream representative of the computed HDR data along with the SL-HDR metadata, the metadata specifying a tone mapping process to be applied to the HDR data. One can note that, since the HDR data are obtained from the SDR data (in step 502), the HDR data with the metadata are representative of the SDR data.

When applying step 612 in the context of SL-HDR, the processing module of the module in charge of generating the SDR data (for example a SL-HDR preprocessor) computes the L-LUT and the B-LUT from the luminance mapping variables and the color correction adjustment variables represented in the SL-HDR metadata received in the ST2108 container.

Then, the processing module generates SDR output data from the formatted HDR input data by applying a TM process based on the L-LUT and the B-LUT. In other words, the processing module applies to the HDR data a tone mapping process specified by the SL-HDR metadata.

One can note that in the coupled ITM/TM process of FIGS. 6A and 6B when applied in the context of SL-HDR1, the SL-HDR metadata are no more generated by the module in charge of the TM process (for example SL-HDR preprocessor) but by the module in charge of the ITM process (for example the ITM tools).

In an embodiment, called first dynamic embodiment, the coupled ITM/TM process of FIGS. 6A and 6B is applied for each image contained in the SDR data obtained in step 501. The module in charge of the TM process (for example the SL-HDR preprocessor or the TM tools for FIG. 3) receives therefore new metadata for each image contained in the HDR data.

In another embodiment, called second dynamic embodiment, the coupled ITM/TM process of FIGS. 6A and 6B is applied for groups of a plurality of images contained in the SDR data obtained in step 501. The module in charge of the TM process (for example the SL-HDR preprocessor or the TM tools for FIG. 3) receives therefore new metadata for each group of a plurality of images contained in the HDR data.

In another embodiment, called fixed embodiment, in step 502, instead of computing dynamically an ITM curve, the ITM curve is fixed for the SDR data. The module in charge of the TM process (for example the SL-HDR preprocessor or the TM tools for FIG. 3) receives therefore fixed metadata for the HDR data one time, for example, at the start of the HDR/SDR contents production. Nevertheless, even with this fixed ITM curve, the SDR-HDR-SDR round trip constraint is respected.

In the following we provide further details on the step 601 of computation of an inverse of the Inverse Tone Mapping curve.

Document ITU-R BT.2446-1 describes in section 4.2 a method for converting SDR contents to HDR contents by using the following expansion function:

$${{Y}^{′}}_{exp} ( P ) = {{Y}^{″} ( P )}^{E ( {Y}^{″} ( P ) )}$$

wherein
Y′ is in the ]0 . . . 1] range
Y″=255.0×Y′
E=a₁Y″²+b₁Y″+c₁ when Y″≤T
E=a₂γ″²+b₂Y″+c₂ when Y″>T
T=70
a₁=1.8712e-5, b₁=−2.7334e-3, c₁=1.3141
a₂=2.8305e-6, b₂=−7.4622e-4, c₂=1.2528

As can be seen, the expansion function is based on a power function whose exponent depends on the luminance value of a current pixel. This is called a global expansion, which means that all input pixels having the same luminance at the input (SDR input) will have the same luminance at the output (HDR output).

Another method, called local expansion, exists which can be expressed in the following way:

$${Y}_{exp} = {Y}_{F}^{G ( {Y}_{F} )} {Y}_{e n h a n c e} ( {Y}^{″} , {Ys}_{i} )$$

where Y_{F} is a filtered version of Y″, G( ) is a gain function of Y_{F} and Y_{enhance} are functions of Y″ and its surrounding pixels Y_{Si}. As can be seen, the method described in the document ITU-R BT.2446-1 is a particular case of the local expansion, wherein Y_{f}=Y″ and Y_{enhance}(Y″, Y_{Si})=1.

In both cases (global or local expansion), the expanded output is monotonic, in order to be consistent with the input SDR image, and when Y at the input is zero, Yₑₓₚ at the output is also zero.

It must be understood that if the expansion method used for an ITM is local, then this method is not bijective, i.e. the SL-HDR preprocessor is not capable to retrieve the SDR data. Retrieving the SDR data is only possible when the expansion method is global (and monotonic as said above) and consequently bijective. Nevertheless, using a local expansion for the ITM can improve the visual quality of the retrieved SDR data by locally adding details.

The same document ITU-R BT.2446-1 describes a method for expanding the chroma part of input SDR data (i.e. UV_{SDR}) by using a chroma scaling factor Sc:

$${UV}_{HDR} = {S}_{c} \cdot {UV}_{SDR}$$

$$with : {S}_{c} = 1 \text{.075} \cdot \frac{{Y}_{HDR}}{{Y}_{SDR}} if {Y}_{SDR} > 0 , {S}_{c} = if {Y}_{SDR} = 0$$

Y_{HDR} being in the range [0 . . . Lₘₐₓ] with Lₘₐₓ=1000 cd/m² and Y_{SDR} being in the range [0 . . . 255]. More generally, the chroma part of the input SDR can be expanded using the following formula:

$${UV}_{HDR} = {S}_{c} \cdot {UV}_{SDR}$$

$$with : {S}_{c} = sat ( {Y}_{SDR} ) \cdot \frac{{Y}_{HDR}}{{Y}_{SDR}} if {Y}_{SDR} > 0 , {S}_{c} = if {Y}_{SDR} = 0$$

where Y_{SDR} can be the SDR luminance, or a filtered SDR luminance or a mix of both and sat( ) a saturation function depending on the Y_{SDR} value. Nevertheless, as explained above, S_{c} must be a function of the SDR luminance (and not of its filtered part) if we try to make a perfect SDR-HDR-SDR round trip.

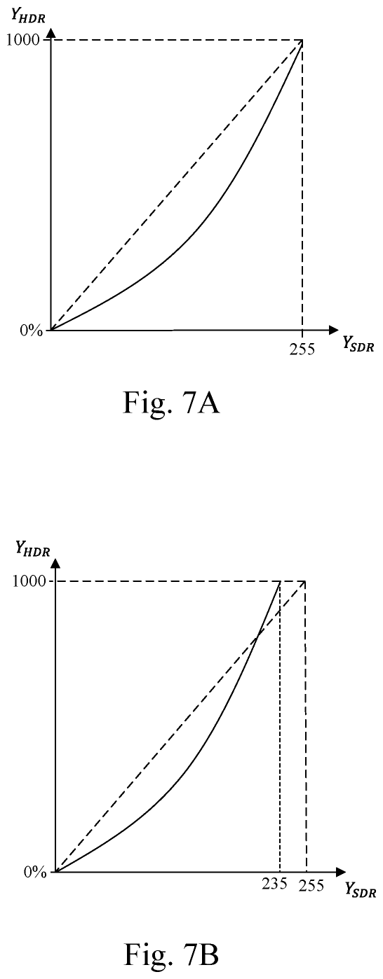

Considering a peak nits of “1000” nits for HDR data, it must be understood that the ITM curve must stay under the peak nits value in order to be reversible. An example of ITM curve is given in FIG. 7A which follows this recommendation. Indeed, each input value is associated with a unique output value.

FIG. 7B illustrates another example of ITM curve which is not fully reversible, i.e. all values of Y_{SDR} above “235” are expanded to “1000”, which means that when converted back to SDR, they will be clipped to “235”.

Inversing an ITM curve is quite easy if the ITM curve is itself obvious. An example of obvious ITM curve is given in the following formula:

$${Y}_{exp} ( Y ) = {Y}^{1.25} * 1 \; 023 / 25 {5}^{1.25}$$

in which the expanded value of Y in the range [0 . . . 255] is mapped in the range [0 . . . 1023]. The reverse curve can be expressed as follows:

$$Y = {( {10}^{( l og Yexp - A )} )}^{1 / 1.25} with A = log ( 1 \; 023 / 25 {5}^{1.25} ) = 1.7 {10}^{- 3}$$

For example, if Y=157, then Yₑₓₚ=557.92. Using the reverse formula:

$$Y = {( {10}^{( l og Yexp - A )} )}^{1 / 1.25} = {( 1 {0}^{( 2.7466 - 0.0017 )} )}^{1 / 1.25} = {( 555.78 )}^{1 / 1.25} = 157$$

A LUT with “1024” entries can then be filled using this formula for each value of Yexp between “0” and “1023”.

However, ITM curves are rarely so obvious (for example when the expansion is done using a gain function which varies with Y: Yₑₓₚ=Y^{G(Y)}, and the difficulty increases if the ITM is a dynamic one, i.e if the gain function depends on criteria extracted from the current image. The ITM curve is then evaluated on the fly (one curve for one image) and the inverted ITM curve follows the same behavior, using look-up-tables.

As an example, consider that:
an ITM look-up-table ITMlut has “1025” inputs and floating-point outputs, and Y in the range [0 . . . 255];
an inverse or reverse ITM look-up-table, RITMlut, has “1025” inputs and floating-point outputs, and Yexp is in the range [0 . . . 1000].
Then:
ITMlut[0] contains the expanded value of Y=0, and ITMlut[1024] contains the expanded value of Y=255. Then each entry i of the ITMlut stores the expanded value of Y=i*255/1024. This expanded value is rescaled from the range [0 . . . 1000] to the range [0 . . . 1024].
RITMlut[0] contains the value Y which produces an expanded value equal to “0”, so RITMlut[0]=0, and RITMlut[1024] contains the value of Y which produces an expanded value equal to “1024” (after the rescaling mentioned above), so RITMlut[1024]=255.

Then, building the inverse ITM look-up-table RITMlut consists in finding for each entry j of the RITMlut (for each value off between “0” and “1024”) a pseudo-entry in the ITM look-up-table ITMlut, i.e an entry located between two successive actual entries of the ITM look-up-table ITMlut, which produces the exact integer value j. This is done using interpolation. Given j, the first integer value i whose value ITMlut[i] is just above j is searched. A value delta is then computed:

$$delta = ITMlut [ i ] - ITMlut [ i - 1 ]$$

and then:

$$RITMlut [ j ] = ( i - 1 ) + ( j - ITMlut [ i - 1 ] ) / delta$$

As a numerical example, one can consider:

ITMlut[500]=200.3 and ITMlut[501]=202.4 then delta=202.4−200.3=2.1.

The values of the inverse ITM look-up-table RITMlut for j=201 and j=202 are the following:

$$RITMlut [ 201 ] = ( 500 + ( 201 - 200 \text{.3} ) / 2.1 ) ⋆ 255 / 1024 = 124 \text{.59}$$

$$RITMlut [ 20 \; 2 ] = ( 500 + ( 202 - 200 \text{.3} ) / 2.1 ) ⋆ 255 / 1024 = 124.71$$

while “500” and “501” make “124.51” and “124.76” when rescaled to 255.

It must be noticed that the highest input values of the inverse ITM look-up-table RITMlut can't be found if the expansion function doesn't rise up to the peak nits. Then these highest values can be set to “255”.

If the inverse ITM look-up-table RITMlut is to be used in an integer context, for example if it must be loaded in a L-LUT whose output is “16” bits integers, then the floating-point numbers of the inverse ITM look-up-table RITMlut are scaled to “65535” and rounded to integer values, which means that “65535” matches with the maximum SDR input value, i.e “255”.

Concerning the chroma components, it has been seen that a general HDR transformation can be expressed as:

$${UV}_{HDR} = sat ( Y ) ⋆ ( {Y}_{HDR} / Y ) ⋆ UV$$

On the SL-HDR side, the B-LUT is addressed by the output of the L-LUT (i.e. the inputs/entries of the B-LUT are the outputs of (i.e. the data contained in) the L-LUT)(then by Y) and the output of the B-LUT is multiplied by UV_{HDR} to retrieve the UV value. The formula above can then be written in the following way:

$${UV}_{HDR} = sat ( Y ) ⋆ {Y}^{G ( Y )} / Y ) ⋆ UV = sat ( Y ) ⋆ ( {Y}^{G ( Y ) - 1} ) ⋆ UV$$

And then

$$UV = {UV}_{HDR} ⋆ ( {Y}^{1 - G ( Y )} / sat ( Y ) )$$

And finally, the B-LUT is a function of Y:

$$B - LUT [ Y ] = {Y}^{1 - G ( Y )} / sat ( Y )$$

G(Y) being the gain function used in the expansion: Y_{HDR}=Y^{G(Y)}.

In the following we provide further details on step 601 of estimation of the metadata from L-LUT and B-LUT.

### Estimation of Luminance Mapping Variables

As described in § 6.2.5 of SL-HDR1 specification, the luminance mapping variables are defined by two sets of parameters:
a first set of parameters containing six parameters used for defining a luminance mapping curve: tmInputSignalBlackLevelOffset, tmInputSignalWhiteLevelOffset, shadowGain, highlightGain, midToneWidthAdjFactor, tmOutputFineTuningNumVal.
a second set of parameters containing a limited number of pairs (tmOutputFineTuningX[i], tmOutputFineTuningY[i]) used in a tone mapping output fine tuning function. These pairs define coordinates of pivot points, the first coordinate tmOutputFineTuningX[i] corresponding to a position of the pivot point and the second coordinate tmOutputFineTuningY[i] corresponding to a value of the pivot point.

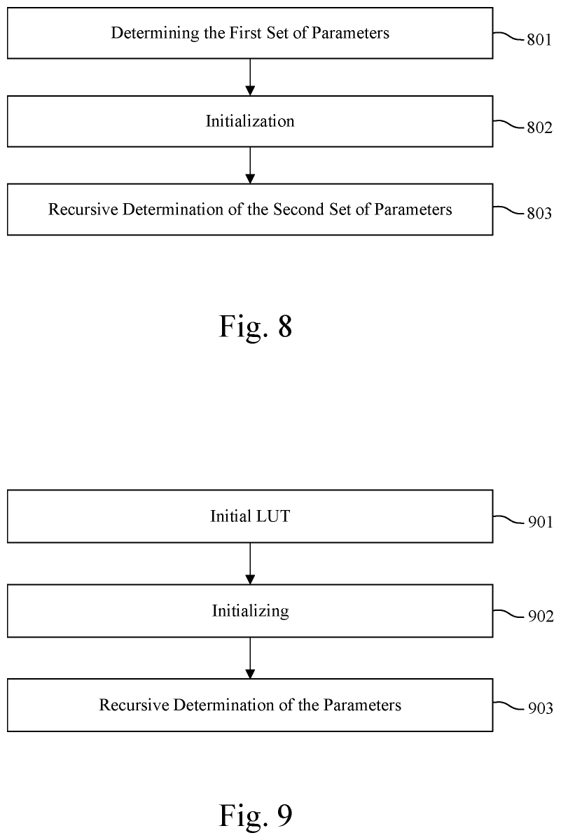

FIG. 8 illustrates an example of process for determining the luminance mapping variables. The process of FIG. 8 is typically applied by each ITM tool (ITM1 202A, ITM2 202B and ITM3 202C) of the HDR production environment of FIG. 3. The process of FIG. 8 is for instance implemented by the processing module detailed later in relation to FIG. 11A.

The two sets of parameters are estimated in two consecutive steps.

In a step 801, the processing module determines the first set of parameters by default, as a function of the HDR peak luminance value, whatever the L-LUT and the B-LUT values are. In other words, the parameters of the first set of parameters are given default values depending on the HDR peak luminance value.

In a variant of step 801, if, once converted into the perceptual uniform domain, the L-LUT look is very far from the luminance mapping curve derived from the default set of parameters, an additional process is achieved. For instance, if the slopes at the origin of L-LUT curve and the luminance mapping curve derived from the default set of parameters differ highly, the parameter shadowGain as defined in the SL-HDR1 specification is modified for a better matching at low luminance levels.

In steps 802 and 803, the processing module determines the second set of parameters recursively by optimizing positions (tmOutputFineTuningX) and values (tmOutputFineTuningY) of the pivot points. In an embodiment of step 802, the number of pivot points (given by the value tmOutputFineTuningNumVal) is fixed to “10”, the maximum possible value according to SL-HDR1 specification. However, tmOutputFineTuningNumVal can also be lower than “10”.

During step 802, the processing module applies an initialization process to the pivot points. In this initialization process, an initial set of pivot points is defined. The number of pivot points in the initial set can be set to different values, from “10” to the number of points in the L-LUT. As an example, the number of pivot points is set to “65”. During the initialization process, each pivot point is given an initial value (tmOutputFineTuningX[i], tmOutputFineTuningY[i]) for i in [0 . . . tmOutputFineTuningNumVal−1].
tmOutputFineTuningX[i]: a given x_{HDR_nits}[i] HDR input luminance comprised between “0” and HDR peak luminance and expressed in nits is converted into the HDR perceptual uniform domain x_{PU_HDR}[i]. The luminance mapping curve derived from the first set of parameters determined in step 801 outputs tmOutputFineTuningX[i] for the input x_{PU_HDR}[i].
tmOutputFineTuningY[i]: the previous x_{HDR_nits}[i] corresponds to an index k[i] at the input of L-LUT. Advantageously, x_{HDR_nits}[i] is chosen such that k[i] is an integer. tmOutputFineTuningY[i] is the conversion of the output L-LUT[k[i]] into the SDR perceptual uniform domain.

In a step 803, the processing module deletes recursively pivot points in order to keep a number tmOutputFineTuningNumVal of pivot points in the set at the end of step 803. A criterion based on a cost function is applied to determine which pivot point can be deleted. Several cost functions can be used:
a cost function corresponding to an error function between the L-LUT and the reconstructed L-LUT based on the estimated parameters;
a cost function corresponding to an error function between an up-sampled version of the tone mapping output fine tuning function with the “65” initial pivot points and an up-sampled version of the tone mapping output fine tuning function with the remaining pivot points.

### Estimation of Color Correction Adjustment Variables

As described in § 6.2.6 of SLHDR1 specification, the color correction adjustment variables consist in a limited number of pairs (saturationGainX[i], saturationGainY[i]) used in the saturation gain function. These pairs define coordinates of pivot points, the first coordinate saturationGainX[i] corresponding to a position of the pivot point and the second coordinate saturationGainY[i] corresponding to a value of the pivot point.

FIG. 9 illustrates an example of process for determining the color correction adjustment variables. The process of FIG. 9 is typically applied by each ITM tool (ITM1 202A, ITM2 202B and ITM3 202C) of the HDR production environment of FIG. 3. The process of FIG. 9 is for instance implemented by the processing module detailed later in relation to FIG. 11A.

In a step 901, the processing module computes an initial LUT SqrtL_over_BetaP as a function of:
the HDR peak luminance value;
the luminance mapping variables estimated above in the process of FIG. 8.

The positions (saturationGainX[i]) and values (saturationGainY[i]) of the pivot points are recursively computed in steps 902 and 903.

In step 902, the processing module applies an initialization process. The recursive process starts again by an initialization process. In this initialization process, the initial set of pivot points is computed. The number of pivot points in the initial set can be set to different values, from “10” to the number of points in the L-LUT. As an example, the number of pivot points is set to “65”. During the initialization process, each pivot point is given an initial value saturationGainY defined as a ratio between the initial LUT SqrtL_over_BetaP and the B-LUT.

In step 903, the processing module deletes recursively pivot points in order to keep a number tmOutputFineTuningNumVal of pivot points in the set at the end of step 903. A criterion based on a cost function is applied to determine which pivot point can be deleted. For example, a cost function corresponding to error function between the B-LUT and the reconstructed B-LUT based on the estimated parameters (i.e. both luminance mapping variables and color correction adjustment variables) is used.

In some cases, a content producer may want to distribute SDR contents that guarantee perfect SDR-HDR-SDR round-trip and that allow HDR reconstruction with the addition of metadata along the distributed SDR content without the need to reuse the HDR content at the production side.

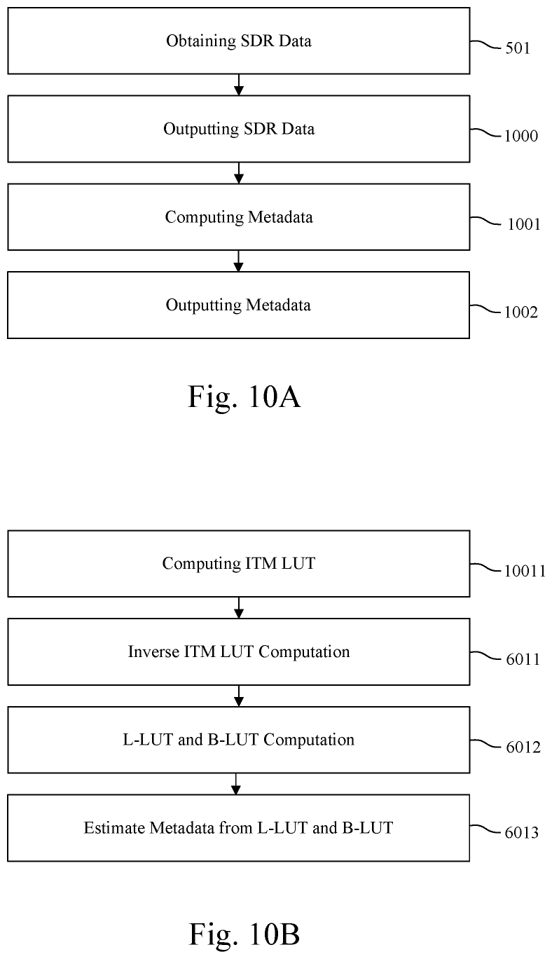

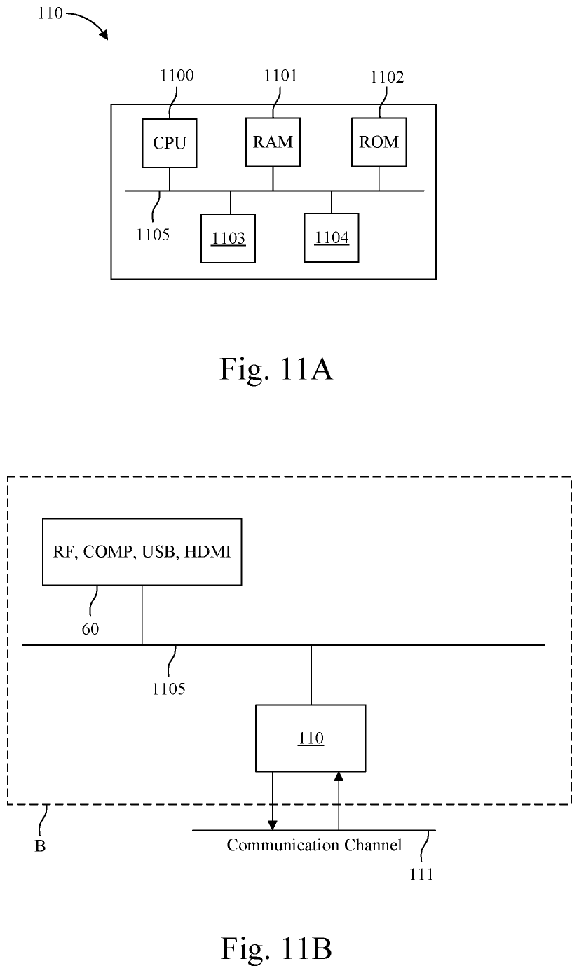

In this case, the coupled process described in relation to FIGS. 6A and 6B can be simplified and replaced by a unified SDR round-trip variant for distribution solution described in FIG. 10A.

FIG. 10A illustrates schematically an example of process according to a variant embodiment. The process of FIG. 10A is typically applied by a module in charge of providing original SDR data that can be then manipulated by other modules for generating HDR and then again SDR from the original SDR data. The process of FIG. 10A is for instance implemented by the processing module detailed later in relation to FIG. 11A.

The process of FIG. 10A starts with the step 501 already explained in relation to FIG. 6A.

In a step 1000, the processing module outputs (i.e. transmits or provides) directly the SDR data obtained in step 501.

In a step 1001, the processing module generates metadata representative of a ITM process to be applied to the SDR data to generate HDR data from these SDR data. More precisely, in step 1001, the processing module computes information representative of an ITM process adapted to generate HDR data from the SDR data (for example, an ITM curve or a TM curve) and inserts this information in metadata.

In a step 1002, the processing module provides (i.e. outputs or transmits) the metadata to a module in charge of generating HDR data from the SDR data along with the outputted SDR data.

FIG. 10B details step 1001 of the process of FIG. 10A in the context of SL-HDR1. In the context of SL-HDR1, the process of FIGS. 10A and 10B is for example applied by a module positioned after the SDR source 201 of FIG. 3.

In a step 10011, the processing module analyzes the SDR input data and computes the most appropriate Inverse Tone Mapping curve for generating HDR data from the SDR data using the result of the analysis.

Step 10011 is followed by steps 6011, 6012 and 6013 already explained in relation to FIG. 6B.

Step 603 is followed by step 1002. In the context of SL-HDR1, during step 1002 the estimated SL-HDR metadata are inserted in the vertical ancillary channel of the SDI interface and directly distributed along with the outputted SDR data.

As can be seen, in steps 1000 and 1002, the processing module provides a stream representative of the SDR data along with the SL-HDR metadata, the SL-HDR metadata specifying a tone mapping process to be applied to HDR data but also indirectly the inverse tone mapping process that would allow obtaining these HDR data.

FIG. 11A illustrates schematically an example of hardware architecture of a processing module 110 comprised in the live production system 20, in a system or module comprised in the live production system 20 such as the ITM tools 202A, 202B and 202C or the TM tools 204B and 204A, in the master central control system 21 or in a system or module of the master central control system 21 such as the ITM tool 211, or in the devices 22A and 22B. The processing module 110 comprises, connected by a communication bus 1105: a processor or CPU (central processing unit) 1100 encompassing one or more microprocessors, general purpose computers, special purpose computers, and processors based on a multi-core architecture, as non-limiting examples; a random access memory (RAM) 1101; a read only memory (ROM) 1102; a storage unit 1103, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 1104 for exchanging data with other modules, devices, systems or equipment. The communication interface 1104 can include, but is not limited to, a transceiver configured to transmit and to receive data over a communication network 111. The communication interface 1104 can include, but is not limited to, a modem or a network card.

For example, the communication interface 1004 enables for instance the processing module 100 to receive the HDR or SDR data and to output HDR or SDR data along with SL-HDR metadata.

The processor 1100 is capable of executing instructions loaded into the RAM 1101 from the ROM 1102, from an external memory (not shown), from a storage medium, or from a communication network. When the processing module 110 is powered up, the processor 1100 is capable of reading instructions from the RAM 1101 and executing them. These instructions form a computer program causing, for example, the implementation by the processor 1100 of ITM or TM processes comprising the processes described in relation to FIGS. 4, 5, 6A, 6B, 8, 9 and 10.

All or some of the algorithms and steps of said processes may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 11C illustrates a block diagram of an example of system A that corresponds to device 22A or 22B in which various aspects and embodiments are implemented.

System A can be embodied as a device including various components or modules and is configured to generate a SDR or HDR content adapted to be displayed on adapted display devices. Examples of such system include, but are not limited to, various electronic systems such as personal computers, laptop computers, smartphones, tablet, TV, or set top boxes. Components of system A, singly or in combination, can be embodied in a single integrated circuit (IC), multiple ICs, and/or discrete components. For example, in at least one embodiment, the system A comprises one processing module 110 that implements a decoding of a SDR or HDR content. In various embodiments, the system A is communicatively coupled to one or more other systems, or other electronic devices, via, for example, a communications bus or through dedicated input and/or output ports.

The input to the processing module 110 can be provided through various input modules as indicated in block 60. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 11C, include composite video.

In various embodiments, the input modules of block 60 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system A to other electronic devices across USB and/or HDMI connections. It is to be understood that various aspects of input processing, for example, Reed-Solomon error correction, can be implemented, for example, within a separate input processing IC or within the processing module 110 as necessary. Similarly, aspects of USB or HDMI interface processing can be implemented within separate interface ICs or within the processing module 110 as necessary. The demodulated, error corrected, and demultiplexed stream is provided to the processing module 110.

Various elements of system A can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system A, the processing module 110 is interconnected to other elements of said system A by the bus 1105.

The communication interface 1104 of the processing module 110 allows the system A to communicate on the communication network 111. The communication network 111 can be implemented, for example, within a wired and/or a wireless medium.

Data is streamed, or otherwise provided, to the system A, in various embodiments, using a wireless network such as a Wi-Fi network, for example IEEE 802.11 (IEEE refers to the Institute of Electrical and Electronics Engineers). The Wi-Fi signal of these embodiments is received over the communications network 111 and the communications interface 1104 which are adapted for Wi-Fi communications. The communications network 111 of these embodiments is typically connected to an access point or router that provides access to external networks including the Internet for allowing streaming applications and other over-the-top communications. Still other embodiments provide streamed data to the system A using the RF connection of the input block 60. As indicated above, various embodiments provide data in a non-streaming manner, for example, when the system A is a smartphone or a tablet. Additionally, various embodiments use wireless networks other than Wi-Fi, for example a cellular network or a Bluetooth network.

The system A can provide an output signal to various output devices using the communication network 111 or the bus 1105. For example, the system A can provide a decoded SDR or HDR signal.

The system A can provide an output signal to various output devices, including a display 64 (if for example the system A is a set top box provided a decoded SDR or HDR signal to a display device), speakers 65, and other peripheral devices 66. The display 64 of various embodiments includes one or more of, for example, a touchscreen display, an organic light-emitting diode (OLED) display, a curved display, and/or a foldable display. The display 64 can be for a television, a tablet, a laptop, a cell phone (mobile phone), or other devices. The display 64 can also be integrated with other components (for example, as in a smart phone), or separate (for example, an external monitor for a laptop). The display device 64 is SDR or HDR content compatible. The other peripheral devices 66 include, in various examples of embodiments, one or more of a stand-alone digital video disc (or digital versatile disc) (DVR, for both terms), a disk player, a stereo system, and/or a lighting system. Various embodiments use one or more peripheral devices 66 that provide a function based on the output of the system A. For example, a disk player performs the function of playing the output of the system A.

In various embodiments, control signals are communicated between the system A and the display 64, speakers 65, or other peripheral devices 66 using signaling such as AV.Link, Consumer Electronics Control (CEC), or other communications protocols that enable device-to-device control with or without user intervention. The output devices can be communicatively coupled to system B via dedicated connections through respective interfaces 61, 62, and 63. Alternatively, the output devices can be connected to system A using the communication network 111 via the communication interface 1104. The display 64 and speakers 65 can be integrated in a single unit with the other components of system A in an electronic device such as, for example, a television. In various embodiments, the display interface 61 includes a display driver, such as, for example, a timing controller (T Con) chip.

The display 64 and speakers 65 can alternatively be separate from one or more of the other components, for example, if the RF module of input 60 is part of a separate set-top box. In various embodiments in which the display 64 and speakers 65 are external components, the output signal can be provided via dedicated output connections, including, for example, HDMI ports, USB ports, or COMP outputs.

FIG. 11B illustrates a block diagram of an example of the system B adapted to implement the live production system 20 or a module or device of the live production system 20 or the master central control system 21, or a module or a device of the live control system 21 in which various aspects and embodiments are implemented.

System B can be embodied as a device including the various components and modules described above and is configured to perform one or more of the aspects and embodiments described in this document.

Examples of such devices include, but are not limited to, various electronic devices such as personal computers, laptop computers, a camera, a smartphone and a server. Elements or modules of system B, singly or in combination, can be embodied in a single integrated circuit (IC), multiple ICs, and/or discrete components. For example, in at least one embodiment, the system B comprises one processing module 110 that implement either an ITM tool (202A, 202B, 202C, 211) or a TM tool (204A, 204B). In various embodiments, the system B is communicatively coupled to one or more other systems, or other electronic devices, via, for example, a communications bus or through dedicated input and/or output ports.

The input to the processing module 110 can be provided through various input modules as indicated in block 60 already described in relation to FIG. 11C.

Various elements of system B can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system B, the processing module 110 is interconnected to other elements of said system B by the bus 1105.

The communication interface 1104 of the processing module 110 allows the system B to communicate on the communication network 111. The communication network 111 can be implemented, for example, within a wired and/or a wireless medium.

Data is streamed, or otherwise provided, to the system B, in various embodiments, using a wireless network such as a Wi-Fi network, for example IEEE 802.11 (IEEE refers to the Institute of Electrical and Electronics Engineers). The Wi-Fi signal of these embodiments is received over the communications network 2 and the communications interface 1104 which are adapted for Wi-Fi communications. The communications network 111 of these embodiments is typically connected to an access point or router that provides access to external networks including the Internet for allowing streaming applications and other over-the-top communications. Still other embodiments provide streamed data to the system B using the RF connection of the input block 60. As indicated above, various embodiments provide data in a non-streaming manner.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), smartphones, tablets, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations or embodiments can produce a variety of signals formatted to carry information that can be, for example, stored or transmitted. The information can include, for example, instructions for performing a method, or data produced by one of the described implementations or embodiments. For example, a signal can be formatted to carry a HDR or SDR image or video sequence and SL-HDR metadata of a described embodiment. Such a signal can be formatted, for example, as an electromagnetic wave (for example, using a radio frequency portion of spectrum) or as a baseband signal. The formatting can include, for example, encoding a HDR or SDR image or video sequence with SL-HDR metadata in an encoded stream and modulating a carrier with the encoded stream. The information that the signal carries can be, for example, analog or digital information. The signal can be transmitted over a variety of different wired or wireless links, as is known. The signal can be stored on a processor-readable medium.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described SDR or HDR data and/or SL-HDR metadata, or variations thereof.
Creating and/or transmitting and/or receiving and/or decoding a bitstream or signal that includes one or more of the described SDR or HDR data and/or SL-HDR metadata, or variations thereof.
A server, camera, TV, set-top box, cell phone, tablet, personal computer or other electronic device that performs at least one of the embodiments described.
A TV, set-top box, cell phone, tablet, personal computer or other electronic device that performs at least one of the embodiments described, and that displays (e.g. using a monitor, screen, or other type of display) a resulting image.
A TV, set-top box, cell phone, tablet, personal computer or other electronic device that tunes (e.g. using a tuner) a channel to receive a signal including encoded SDR or HDR data and/or SL-HDR metadata, and performs at least one of the embodiments described.
A TV, set-top box, cell phone, tablet, or other electronic device that receives (e.g. using an antenna) a signal over the air that includes SDR or HDR data and/or SL-HDR metadata, and performs at least one of the embodiments described.
A server, camera, cell phone, tablet, personal computer or other electronic device that tunes (e.g. using a tuner) a channel to transmit a signal including SDR or HDR data and/or SL-HDR metadata, and performs at least one of the embodiments described.
A server, camera, cell phone, tablet, personal computer or other electronic device that transmits (e.g. using an antenna) a signal over the air that includes SDR or HDR data and/or SL-HDR metadata, and performs at least one of the embodiments described.

1. A method comprising:
applying an inverse tone mapping process comprising:
obtaining first standard dynamic range data;
obtaining information representative of an inverse tone mapping process adapted to generate high dynamic range data from the first standard dynamic range data and inserting the information in metadata; and
generating high dynamic range data from the first standard dynamic range data using the information representative of an inverse tone mapping process inserted in the metadata; and
applying a pre-processing process comprising:
obtaining the high dynamic range data and the metadata; and
generating second standard dynamic range data from the high dynamic range data applying a tone mapping process derived from the information representative of an inverse tone mapping process inserted in the metadata.

2. (canceled)

3. The method according to claim 1 wherein the information is representative of an inverse tone mapping curve or of a tone mapping curve.

4. The method according to claim 3 comprising, responsive to the information is representative of a tone mapping curve, computing an inverse of the inverse tone mapping curve used to define the inverse tone mapping process.

5. The method according to claim 4 comprising computing a first look-up table and a second look-up table from the inverse of the inverse tone mapping curve, the first look-up table being adapted for tone mapping a luminance component of high dynamic range data and the second look-up table being adapted for correcting color components of the high dynamic range data and estimating first variables representative of a tone mapping function and second variables representative of a color correction function from the first and second look-up tables, the first and the second variables being the information representative of the inverse tone mapping process inserted in the metadata.

6. The method of claim 1 wherein the method is applied for each picture of the first standard dynamic range data or for groups of pictures of the first standard dynamic range data.

7-11. (canceled)

12. A device comprising electronic circuitry configured for:
applying an inverse tone mapping process comprising:
obtaining first standard dynamic range data;
obtaining information representative of an inverse tone mapping process adapted to generate high dynamic range data from the first standard dynamic range data and inserting the information in metadata; and
generating high dynamic range data from the first standard dynamic range data using the information representative of an inverse tone mapping process inserted in the metadata; and
applying a pre-processing process comprising:
obtaining the high dynamic range data and the metadata; and
generating second standard dynamic range data from the high dynamic range data applying a tone mapping process derived from the information representative of an inverse tone mapping process inserted in the metadata.

13. (canceled)

14. The device according to claim 12 wherein the information is representative of an inverse tone mapping curve or of a tone mapping curve.

15. The device according to claim 14 wherein, responsive to the information is representative of a tone mapping curve, the electronic circuitry is further configured for computing an inverse of an inverse tone mapping curve used to define the inverse tone mapping process.

16. The device according to claim 15 wherein, the electronic circuitry is further configured for computing a first look-up table and a second look-up table from the inverse of the inverse tone mapping curve, the first look-up table being adapted for tone mapping a luminance component of high dynamic range data and the second look-up table being adapted for correcting color components of the high dynamic range data and for estimating first variables representative of a tone mapping function and second variables representative of a color correction function from the first and second look-up tables, the first and the second variables being the information representative of the inverse tone mapping process inserted in the metadata.

17-24. (canceled)

25. Non-transitory information storage medium storing program code instructions for implementing the method according to claim 1.

26. Non-transitory information storage medium storing program code instructions for implementing the method according to claim 3.

27. Non-transitory information storage medium storing program code instructions for implementing the method according to claim 4.

28. Non-transitory information storage medium storing program code instructions for implementing the method according to claim 5.

29. Non-transitory information storage medium storing program code instructions for implementing the method according to claim 6.
